(19) United States
(12) Patent Application Publication
(10) Pub. No.: US 2009/0315509 A1
(43) Pub. Date: Dec. 24, 2009

(54) Socket with switches and USB charge slots

(75) Inventor: Johnson Wu, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Holageo Enterprise Co., Ltd., Tainan Hsien (TW)

(21) Appl. No.: 12/213,723

(22) Filed: Jun. 24, 2008

(51) Int. Cl. H02J 7/00

(52) U.S. Cl. 320/107

(57) ABSTRACT

A socket with switches and USB slots includes bottom base, a cover closed on the bottom base and a voltage transforming circuit board fixed in the socket. The voltage transforming circuit transforms voltage of a power source, having an input terminal connected with the power and an output terminal formed with a USB slot. Then the voltage transformed and rectified by the circuit is the same as that of an USB slot of a common computer host, and sent to the output terminal or the USB slot. The cover has a hole corresponding to the USB slot of the voltage transforming circuit. Then an electric appliance such as a cell phone can be charged by connecting one end of the USB power line with the electronic appliance and the other end of the USB power line inserted through the hole of the cover and into the USB slot, without need of using a conventional power line with a large and heavy transformer.

### BACKGROUND OF THE INVENTION

1. Field of the Invention

This invention relates to a socket with switches, particularly to one fixed on a wall, transferable one or an extensive one provided with USB charge slots that, so it is convenient for an electronic appliance to use a USB power line to connect to the USB charge slot that it has for charging, without need of using a power line with a large heavy transformer.

2. Description of the Prior Art

If an electronic appliance such as a cell phone is to be charged, it is common that a charge power line with a transformer has to be used by one end of the power line connected to the electronic appliance, and the other end with a plug inserted in the slots of the socket with a switch.

However, the conventional charge power line with a transformer is quite inconvenient to carry around because of the large dimension and the heavy weight of the transformer.

### SUMMARY OF THE INVENTION

The purpose of the invention is to offer a socket with switches and USB charge slots, which is convenient for charging an electronic appliance by using a USB power line to connect to the USB charge slots in the socket.

The main feature of the invention is a transforming circuit board installed in the socket for transforming voltage of the power source. The power input of the transforming circuit board is connected to the power source so that the voltage of the power source is transformed and then rectified, and the output is a USB slot aligned to a hole bored in a cover of the socket, useful for the USB power line of an electronic appliance to insert in the slot for charging.

### BRIEF DESCRIPTION OF DRAWINGS

This invention will be better understood by referring to the accompanying drawings, wherein:

FIG. 1 is a perspective view of a preferred embodiment of a socket with switches and USB charge slots in the present invention;

FIG. 2 is a first exploded perspective view of the preferred embodiment of a socket with switches and USB charge slots in the present invention;

FIG. 3 is a second exploded perspective view of the preferred embodiment of a socket with switches and USB charge slots in the present invention;

FIG. 4 is a third exploded perspective view of the preferred embodiment of socket with switches and USB charge slots in the present invention;

FIG. 5 is an upper view of the preferred embodiment of a socket with switches and USB charge slots in the present invention; and

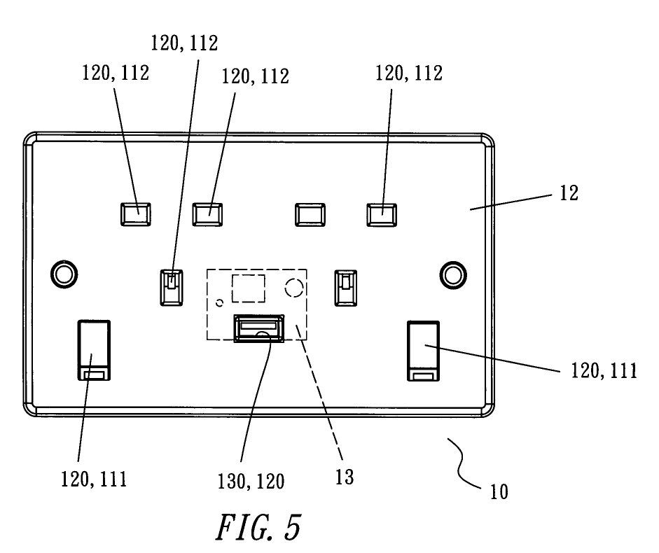

FIG. 6 is a perspective view of the socket with switches and USB chares slots used with an electronic appliance in the present invention.

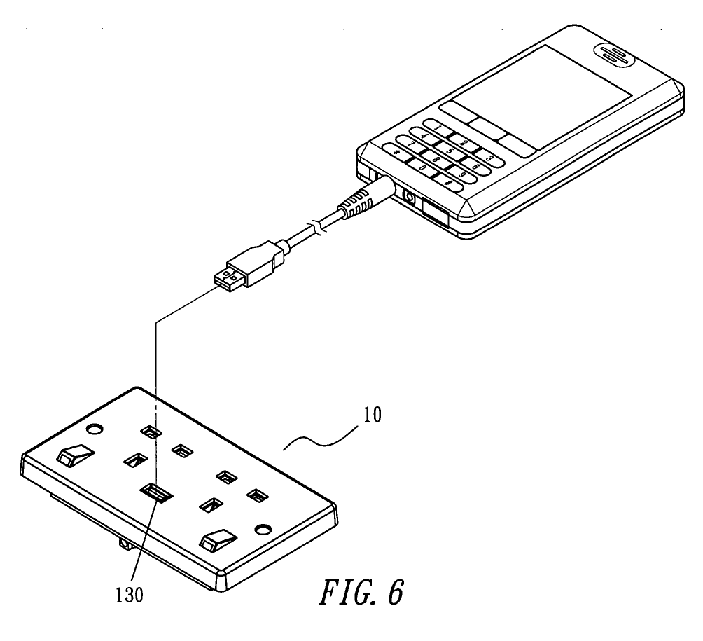

### DETAILED DESCRIPTION OF THE PREFERRED EMBODIMENT

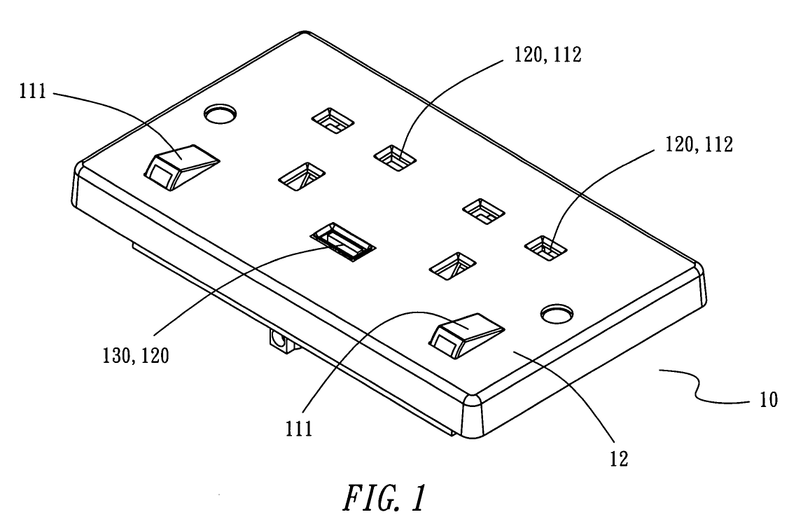

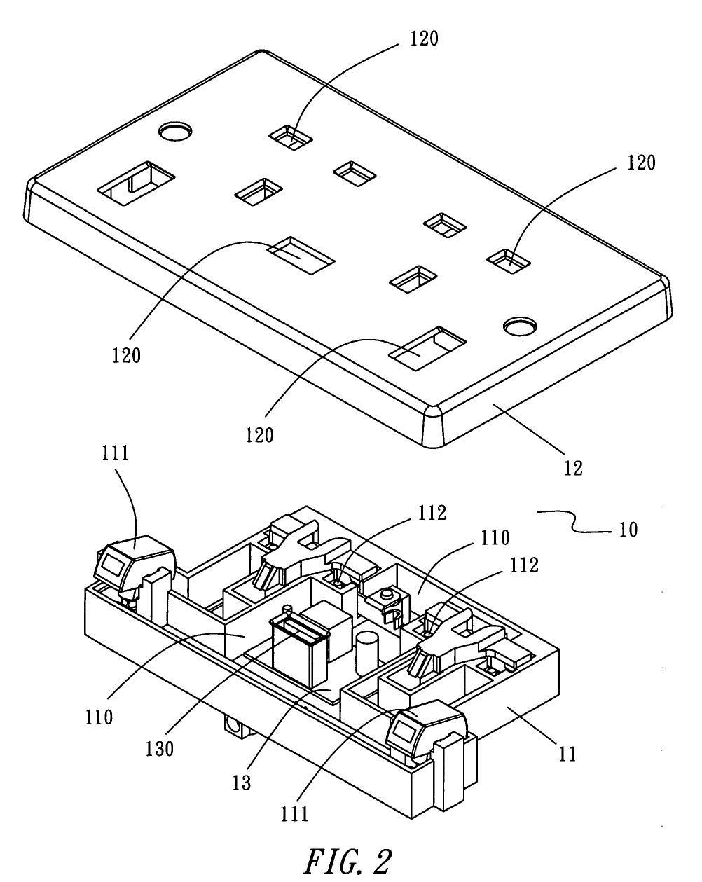

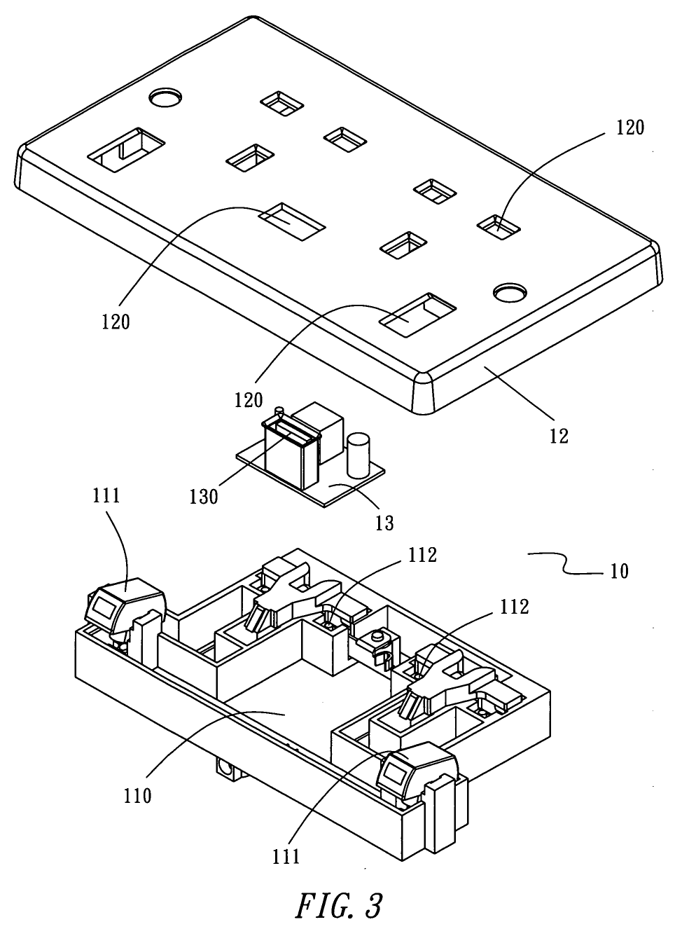

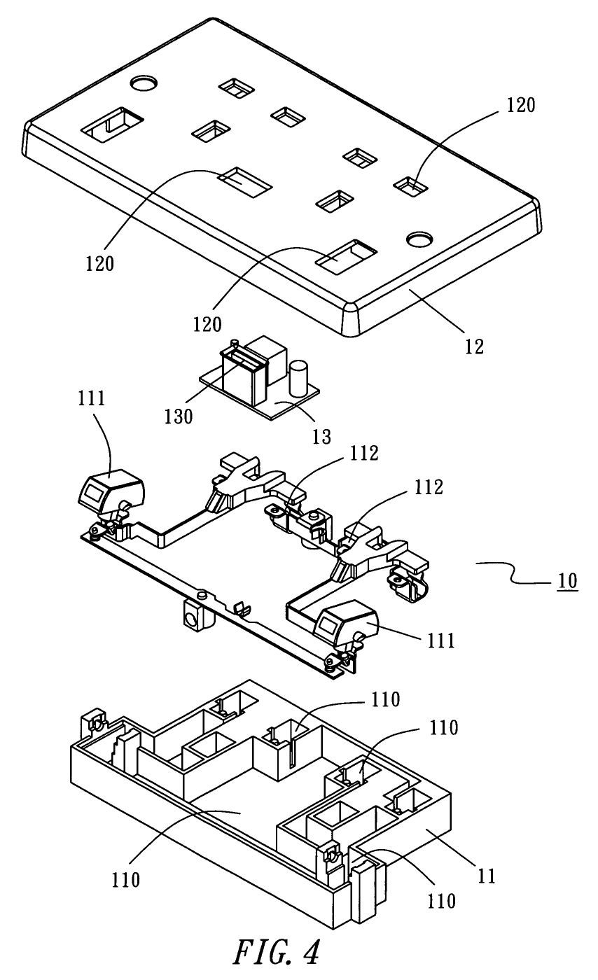

A socket with switches and USB charge slots in the present invention, as shown in FIGS. 1-4, includes a bottom base 11, and a cover 12.

The bottom base is provided with a plurality of compartments 110, a press switch 111 fixed in each of the compartments 110 and a insert slot 112 in each of the compartments 110.

The cover 12 is tightly fixed on the bottom base 11, provided with plural holes 120 corresponding to the press switches 111 to extend through upward and the insert slots 112 for pins of plugs to pass through.

What is improved in this invention is a transforming circuit board 13 fixed in the bottom base 11, which is provided with a power input terminal to connect with a power source connected to the socket 10, transforming the voltage of the power and rectifying, and an output terminal being a USB slot 130. The output voltage of the USB slot is the same as that of the output voltage of the USB slot of a computer host.

Then the cover 12 also has a hole 120 to correspond to the USB slot 130.

When a common electronic appliance such as a cell phone is to be charged, one end of the USB power source line is connected to the cell phone, and the other end is inserted into the hole 120 aligned to the USB slot 130. So this invention is more convenient to use than a conventional power line with a transformer that is both heavy and large for carrying around.

Moreover, this invention can also be applied to a wall socket with switches, a transfer-type socket with switches or an extensive socket with switches.

While the preferred embodiment of the invention has been described above, it will be recognized and understood that various modifications may be made therein and the appended claims are intended to cover all such modifications that may fall within the spirit and scope of the invention.

What is claimed is:

1. A socket with switches and USB charge slots, said socket comprising:
A bottom base;
A cover closed on said bottom base and an interior space defined by said bottom base and said cover, said cover provided with plural holes;
a voltage transforming circuit board provided with voltage transforming function for a power source fixed in said interior space in said socket formed by said bottom base and said cover, said voltage transforming circuit having an output terminal connected to said power source connected to said socket, said voltage transforming circuit further having an output terminal formed with an USB slot, said a cover having a hole corresponding to said USB slot so that a USB power line of an electronic appliance may be inserted through said hole and in said USB slot for charging said electronic appliance.

2. The socket with switches and USB slots as claimed in claim 1, wherein an output voltage of said USB slots is the same as that of an USB slot of a common computer host.

3. The socket with switches and USB slots as claimed in claim 1, wherein said socket with switches and USB slots is possible to be fixed on a wall.

4. The socket with switches and USB slots as claimed in claim 1, wherein said socket with switches and USB slots is a transfer-style socket with switches.

5. The socket with switches and USB slots as claimed in claim 1, wherein said socket with switches and USB slots is an extensive socket with switches.
